(19) United States
(12) Patent Application Publication
(10) Pub. No.: US 2012/0153859 A1
(43) Pub. Date: Jun. 21, 2012

(54) DRIVING CIRCUIT FOR DRIVING LIGHT EMITTING DIODES AND SIGNAL-EXTENDING CIRCUIT APPLIED TO A DRIVING CIRCUIT FOR DRIVING LIGHT EMITTING DIODES

(75) Inventors: Chih-Hung Wu, Taipei City (TW); Yung-Chun Chuang, Taipei City (TW); Chu-Rung Lee, Chiayi City (TW)

(73) Assignee: ADVANCED ANALOG TECHNOLOGY, INC., HSINCHU (TW)

(21) Appl. No.: 12/970,918

(22) Filed: Dec. 16, 2010

(51) Int. Cl. H05B 41/16; H05B 37/02

(52) U.S. Cl. 315/287; 315/294

(57) ABSTRACT

A driving circuit for driving light emitting diodes includes a signal-extending circuit and a current sink. The signal-extending circuit is used for receiving an original dimming signal and extending a duty cycle of the original dimming signal. The current sink is coupled to the signal-extending circuit for generating a driving current for driving a series of light emitting diode.

### BACKGROUND OF THE INVENTION

1. Field of the Invention

The present invention is related to a driving circuit for driving light emitting diodes.

2. Background Description

Light emitting diodes (LEDs) are turned on or off by driving circuits. Burst-mode dimming is a method whereby a driving circuit turns on or turns off an LED by turning on or turning off a driving current according to a pulse width modulation (PWM) dimming signal. Brightness of the LED is proportional to an average value of the driving current, which is adjusted linearly by adjusting a duty cycle of the PWM dimming signal.

The driving current is controlled by a power metal-oxide-semiconductor (MOS) transistor of a current sink. However, the power MOS transistor does not turn on instantaneously. When the PWM dimming signal transition is changed from a low voltage to a high voltage, the driving current for driving the light emitting diode exhibits a delay time and a rising time before stabilizing. FIG. 1 is a diagram illustrating practical average value of the driving current being not equal to an average value of an ideal current due to the delay time of the driving current during rising. Shown in FIG. 1, the delay time of the driving current during rising is more substantial than the delay time of the driving current during falling. When a high contrast PWM dimming signal is applied to dim the luminance of the light emitting diode, accuracy of the driving current is limited by a bottleneck caused by non-ideal characteristics of the abovementioned power MOS transistor. Particularly, error of the driving current caused by the delay time and the rising time is more obvious when the duty cycle of the PWM dimming signal is very short, which seriously affects the accuracy of the driving current. In addition, the non-ideal characteristics of the abovementioned power MOS transistor vary with process variation of a fabrication process utilized to fabricate the MOS transistor.

### SUMMARY OF THE INVENTION

An embodiment provides a driving circuit for driving light emitting diodes. The driving circuit includes a signal-extending circuit and a current sink. The signal-extending circuit is used for receiving an original dimming signal and extending a duty cycle of the original dimming signal to generate a new dimming signal. The current sink is coupled to the signal-extending circuit for generating a driving current for driving a series of light emitting diodes according to the new dimming signal.

Another embodiment provides a signal-extending circuit applied to a driving circuit for driving light emitting diodes. The signal-extending circuit includes a first time-extending circuit. The first time-extending circuit is used for generating a first extending time for extending a duty cycle of an original dimming signal. The first time-extending circuit includes a first metal-oxide-semiconductor transistor, a first capacitor, and a second metal-oxide-semiconductor transistor. The first metal-oxide-semiconductor transistor is used for receiving the original dimming signal. The first capacitor is coupled to the first metal-oxide-semiconductor transistor for generating the first extending time. The second metal-oxide-semiconductor transistor is used for outputting a first extended dimming signal.

A driving circuit for driving light emitting diodes utilities a first time-extending circuit and a second time-extending circuit of a signal-extending circuit to generate a first extending time and a second extending time that vary with processes of the MOS transistors of the driving circuit for extending the duty cycle of the original dimming signal. Therefore, the driving circuit compensates the original dimming signal dynamically with the processes of the MOS transistors to generate a driving current more accurately.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a practical average value of the driving current being not equal to an average value of an ideal current due to the delay time and the rising time of the driving current.

FIG. 2 illustrates a driving circuit for driving light emitting diodes according to an embodiment.

FIG. 3 illustrates the signal-extending circuit of the driving circuit according to another embodiment.

FIG. 4 illustrates a driving circuit for driving light emitting diodes according to another embodiment.

FIG. 5 illustrates the signal-extending circuit of the driving circuit according to another embodiment.

FIG. 6A illustrates the signal-extending circuit extending the duty cycle of the original dimming signal to generate the first extended dimming signal.

FIG. 6B illustrates the signal-extending circuit extending the duty cycle of the first extended dimming signal to generate the second extended dimming signal.

### DETAILED DESCRIPTION

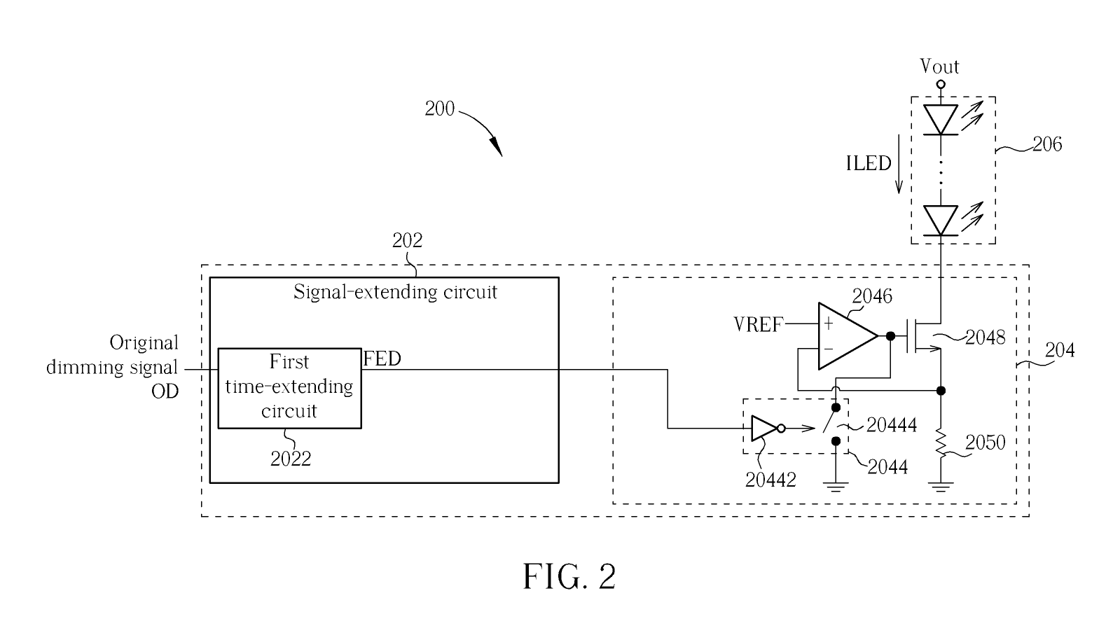

FIG. 2 is a diagram illustrating a driving circuit 200 for driving light emitting diodes according to an embodiment. The driving circuit 200 includes a signal-extending circuit 202 and a current sink 204. The signal-extending circuit 202 includes a first time-extending circuit 2022. The signal-extending circuit 202 is used for receiving an original dimming signal OD and extending a duty cycle of the original dimming signal OD to generate a first extended dimming signal FED with a larger duty cycle. The current sink 204 is coupled to the signal-extending circuit 202 for generating a driving current ILED for driving a series of light emitting diodes 206 according to the first extended dimming signal FED, where a voltage Vout is a driving voltage for driving the series of light emitting diodes 206.

As shown in FIG. 2, the current sink 204 includes a switch circuit 2044, an amplifier 2046, a power MOS transistor 2048, and a resistor 2050. The switch circuit 2044 includes an inverter 20442 and a switch 20444. The inverter 20442 is coupled to the signal-extending circuit 202 for inverting the first extended dimming signal FED, and the first extended dimming signal FED after being inverted is used for controlling turning-on and turning-off of the switch 20444, where the switch 20444 is an N-type MOS transistor.

When the switch 20444 is turned on, which may correspond to the first extended dimming signal FED being a low voltage, a voltage of an output terminal of the amplifier 2046 is pulled down to ground. Because a second terminal of the power MOS transistor 2048 is coupled to the output terminal of the amplifier 2046, the power MOS transistor 2048 is turned off, resulting in the driving current ILED flowing through the resistor 2050 also being turned off.

When the switch 20444 is turned off, which may correspond to the first extended dimming signal FED being a high voltage, the voltage of the output terminal of the amplifier 2046 is not pulled down to the ground. Therefore, the driving current ILED driving the series of light emitting diodes 206 may be generated according to the voltage of the output terminal of the amplifier 2046.

The power MOS transistor 2048 has a first terminal coupled to the series of light emitting diodes 206, a second terminal coupled to the output terminal of the amplifier 2046, and a third terminal coupled to a negative input terminal of the amplifier 2046. The power MOS transistor 2048 is an N-type high voltage MOS transistor. The voltage of the output terminal of the amplifier 2046 may drive the power MOS transistor 2048 to operate in a saturation region. Therefore, the power MOS transistor 2048 may act as a current source, and the driving current ILED driving the series of light emitting diodes 206 may flow through the power MOS transistor 2048 and the resistor 2050 to the ground.

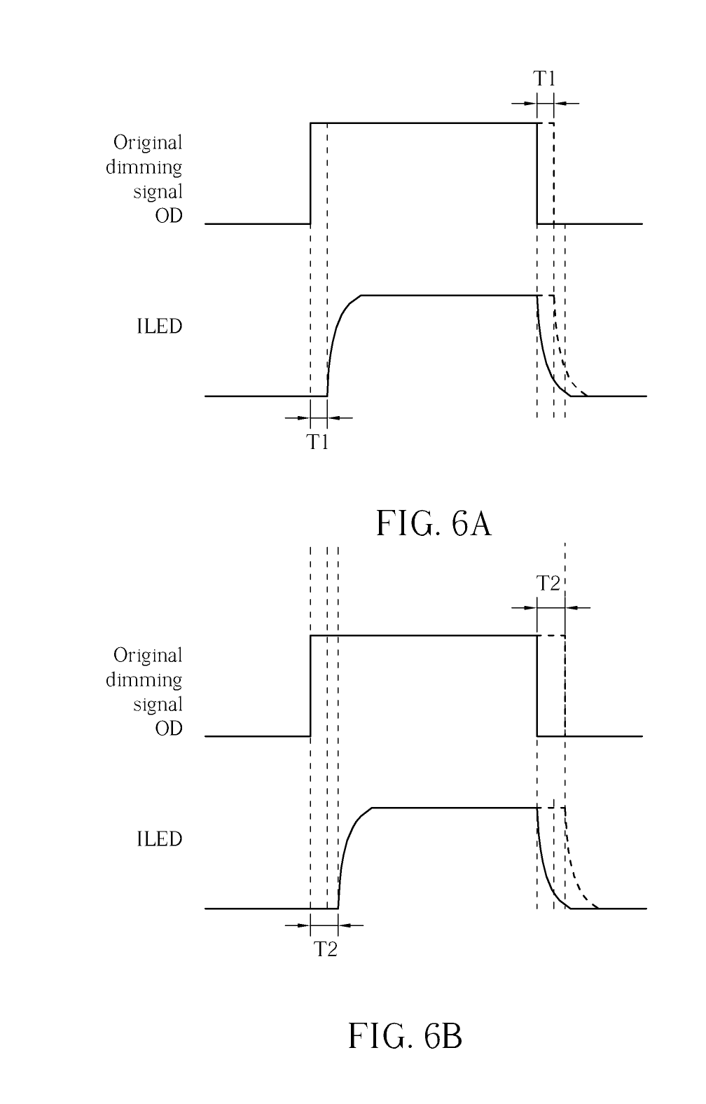

When the original dimming signal OD transition is changed from a low voltage to a high voltage, the driving current ILED for driving the series of light emitting diodes 206 may undergo a delay time and a rising time before the driving current ILED stabilizes due to parasitic capacitors of MOS transistors of the driving circuit 200. In addition, because the MOS transistors of the driving circuit 200 discharge to the ground, a falling time of the driving current ILED is shorter than the rising time of the driving current ILED. Therefore, as shown in FIG. 2, after the signal-extending circuit 202 receives the original dimming signal OD, the signal-extending circuit 202 generates a first extending time (T1, shown in FIG. 6A) to extend the duty cycle of the original dimming signal OD, so as to compensate for non-ideal characteristics of the driving current ILED. That is to say, the first extended dimming signal extends an additional time of the original dimming signal OD, and where the additional time of the original dimming signal OD is substantially the same as the delay time during rising of the driving current.

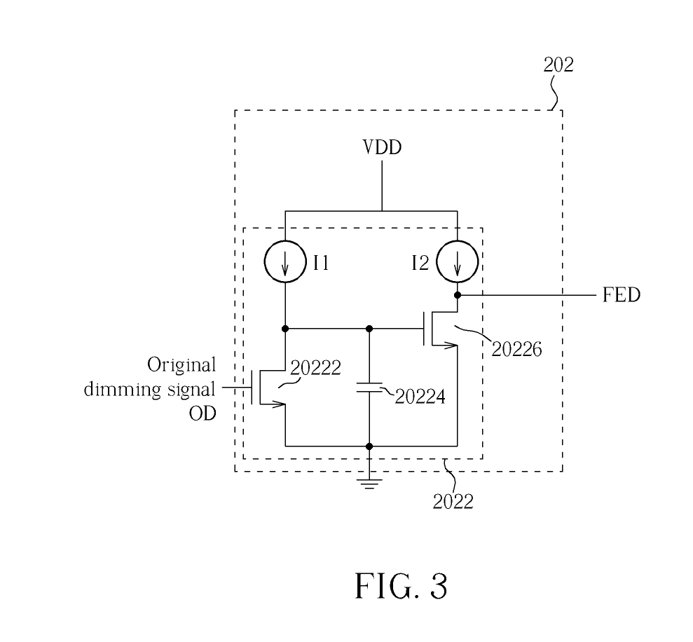

FIG. 3 is a diagram illustrating the signal-extending circuit 202 of the driving circuit 200 according to another embodiment. The signal-extending circuit 202 includes the first time-extending circuit 2022. The first time-extending circuit 2022 is used for generating the first extending time (T1) to extend the duty cycle of the original dimming signal OD. The first time-extending circuit 2022 includes a first metal-oxide-semiconductor transistor 20222, a first capacitor 20224, a second metal-oxide-semiconductor transistor 20226, a first current source I1, and a second current source 12. The first metal-oxide-semiconductor transistor 20222 has a first terminal coupled to the first current source I1, a second terminal for receiving the original dimming signal OD, and a third terminal coupled to the ground. The first capacitor 20224 has a first terminal coupled to the first terminal of the first metal-oxide-semiconductor transistor 20222, and a second terminal coupled to the ground. The second metal-oxide-semiconductor transistor 20226 has a first terminal coupled to the second current source 12 for outputting the first extended dimming signal FED, a second terminal coupled to the first terminal of the first capacitor 20224, and a third terminal coupled to the ground, where the second metal-oxide-semiconductor transistor 20226 and the power MOS transistor 2048 are made by the same semiconductor process. As shown in FIG. 3, when the original dimming signal OD transition is changed from the low voltage to the high voltage, the first metal-oxide-semiconductor transistor 20222 is turned on and the second metal-oxide-semiconductor transistor 20226 is turned off, so as to pull the first extended dimming signal FED from the low voltage to the high voltage. When the original dimming signal OD is changed from the high voltage to the low voltage, the first metal-oxide-semiconductor transistor 20222 is turned off and the first capacitor 20224 is charged by the first current source I1, so as to delay the time to turn on the second metal-oxide-semiconductor transistor 20226. Therefore, the first time-extending circuit 2022 can generate the first extending time (T1) for extending the duty cycle of the original dimming signal OD.

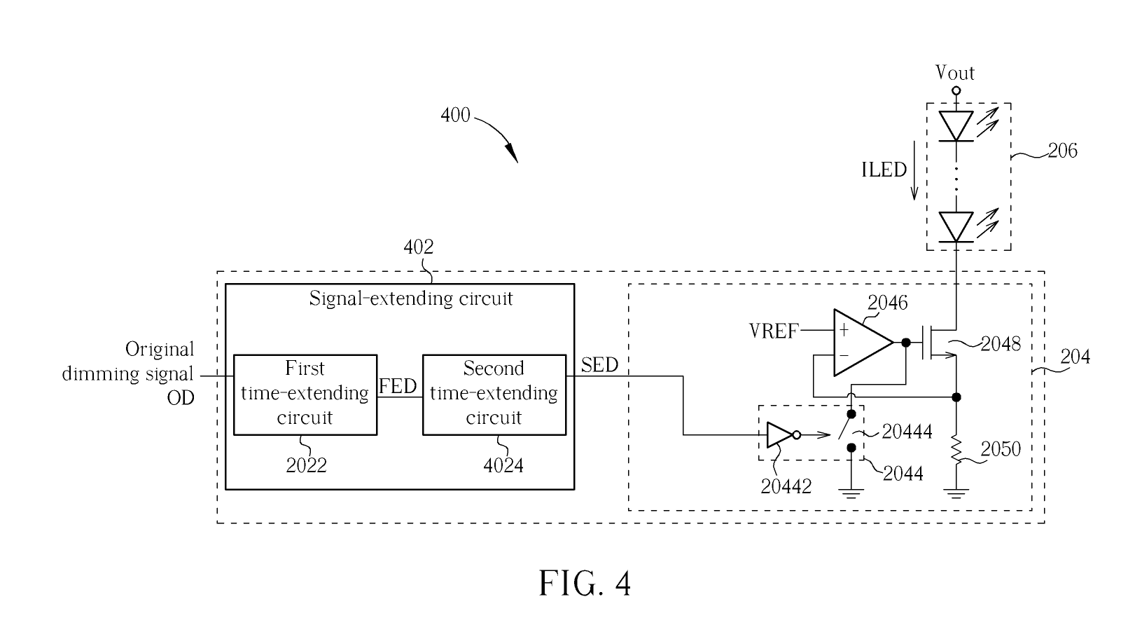

FIG. 4 is a diagram illustrating a driving circuit 400 for driving light emitting diodes according to another embodiment. A difference between the driving circuit 200 and the driving circuit 400 is that the signal-extending circuit 402 further comprises a second time-extending circuit 4024. The second time-extending circuit 4024 is coupled to the first time-extending circuit 2022 for generating a second extending time (T2, shown in FIG. 6B) for extending a duty cycle of the first extended dimming signal FED. Subsequent operation principles of the driving circuit 400 are the same as those of the driving circuit 200, so further description thereof is omitted.

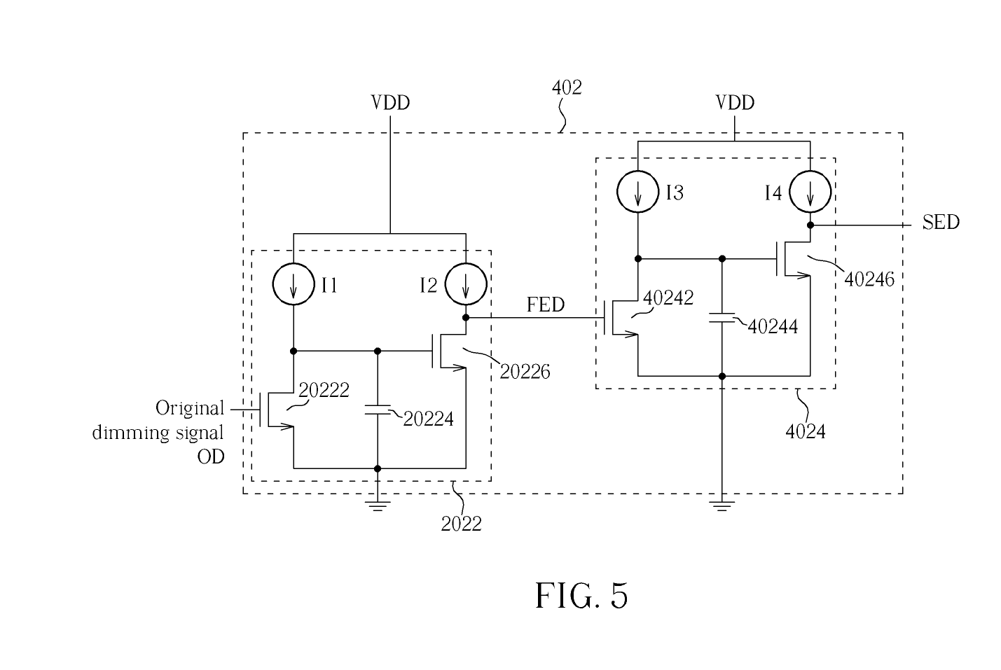

FIG. 5 is a diagram illustrating the signal-extending circuit 402 of the driving circuit 400 according to another embodiment. The second time-extending circuit 4024 includes a third metal-oxide-semiconductor transistor 40242, a second capacitor 40244, a fourth metal-oxide-semiconductor transistor 40246, a third current source I3, and a fourth current source I4. The third metal-oxide-semiconductor transistor 40242 has a first terminal coupled to the third current source I3, a second terminal for receiving the first extended dimming signal FED, and a third terminal coupled the ground. The second capacitor 40244 has a first terminal coupled to the first terminal of the third metal-oxide-semiconductor transistor 40242, and a second terminal coupled to the ground. The fourth metal-oxide-semiconductor transistor 40246 has a first terminal coupled to the fourth current source I4 for outputting a second extended dimming signal SED, a second terminal coupled to the first terminal of the second capacitor 40244, and a third terminal coupled to the ground, where the fourth metal-oxide-semiconductor transistor 40246 and metal-oxide-semiconductor transistors within the amplifier 2046 are made by the same semiconductor process. Subsequent operation principles of the second time-extending circuit 4024 are the same as those of the first time-extending circuit 2022, so further description thereof is omitted.

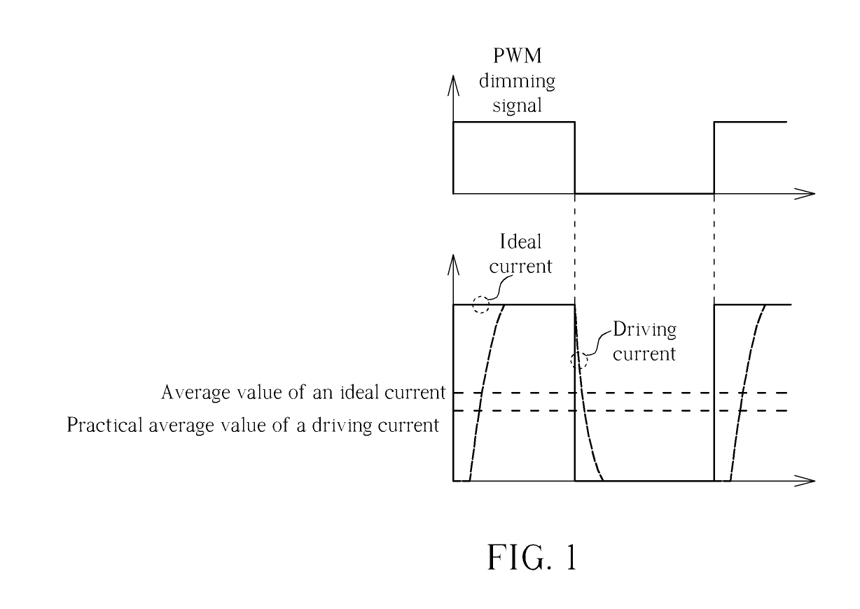

FIG. 6A is a diagram illustrating the signal-extending circuit 202 extending the duty cycle of the original dimming signal OD to generate the first extended dimming signal FED. The extended time is about the same as the delay of the ILED current rising to compensate the delay of the rising of the ILED current, so that the pulse widths of OD and ILED are about the same, and thus the average current of ILED is maintained. The duty cycle of the original dimming signal OD is about the same as the duty cycle of the ILED current. The average current of ILED does not become smaller as in FIG. 1 and the drawback in FIG. 1 is cured. Because the second metal-oxide-semiconductor transistor 20226 and the same as the power MOS transistor 2048 are made by the same semiconductor process, the first extending time (T1) varies with the power MOS transistor 2048 when the power MOS transistor 2048 varies.

FIG. 6B is a diagram illustrating the signal-extending circuit 402 extending the duty cycle of the first extended dimming signal FED to generate the second extended dimming signal SED. Because the second time-extending circuit 4024 is related to the metal-oxide-semiconductor transistors (not shown) inside the amplifier 2046, the second extending time (T2) varies with the metal-oxide-semiconductor transistors within the amplifier 2046 when the metal-oxide-semiconductor transistors within the amplifier 2046 vary. Similar to FIG. 6A, the extended time is about the same as the delay of the ILED current rising to compensate the delay of the rising of the ILED current, so that the pulse widths of OD and ILED are about the same, and thus the average current of ILED is maintained. The duty cycle of the original dimming signal OD is about the same as the duty cycle of the ILED current.

To sum up, the driving circuit for driving light emitting diodes described above includes the signal-extending circuit and the current sink. The signal-extending circuit utilizes the first time-extending circuit and the second time-extending circuit to generate the first extending time and the second extending time that vary with processes of the MOS transistors of the driving circuit for extending the duty cycle of the original dimming signal. Therefore, the driving circuit can compensate the original dimming signal dynamically with the process of the MOS transistors to generate the driving current more accurately.

Those skilled in the art will readily observe that numerous modifications and alterations of the device and method may be made while retaining the teachings of the invention.

What is claimed is:

1. A driving circuit for driving light emitting diodes, the driving circuit comprising:
a signal-extending circuit for receiving an original dimming signal and extending a duty cycle of the original dimming signal to generate a new dimming signal; and
a current sink coupled to the signal-extending circuit for generating a driving current for driving a series of light emitting diodes according to the new dimming signal, wherein the original dimming signal is a pulse width modulation signal.

2. The driving circuit of claim 1, wherein the driving current has a delay during rising, and the new dimming signal extends an additional time of the original dimming signal, and wherein the additional time of the original dimming signal is substantially the same as the delay during rising of the driving current.

3. The driving circuit of claim 1, wherein the signal-extending circuit comprises:
a first time-extending circuit for generating a first extending time for extending the duty cycle of the original dimming signal, the first time-extending circuit comprising:
a first metal-oxide-semiconductor transistor for receiving the original dimming signal;
a first capacitor coupled to the first metal-oxide-semiconductor transistor for generating the first extending time; and
a second metal-oxide-semiconductor transistor coupled to the first metal-oxide-semiconductor transistor for outputting a first extended dimming signal.

4. The driving circuit of claim 3, wherein the first extended dimming signal is the new dimming signal.

5. The driving circuit of claim 3, wherein the signal-extending circuit further comprises:
a second time-extending circuit coupled to the first time-extending circuit for generating a second extending time for extending a duty cycle of the first extended dimming signal, the second time-extending circuit comprising:
a third metal-oxide-semiconductor transistor for receiving the first extended dimming signal;
a second capacitor coupled to the third metal-oxide-semiconductor transistor for generating the second extending time; and
a fourth metal-oxide-semiconductor transistor coupled to the third metal-oxide-semiconductor transistor for outputting a second extended dimming signal.

6. The driving circuit of claim 5, wherein the second extended dimming signal is the new dimming signal.

7. The driving circuit of claim 1, wherein the current sink comprises:
a switch circuit coupled to the signal-extending circuit;
an amplifier having a first input terminal for receiving a reference voltage, a second input terminal, and an output terminal coupled to the switch circuit;
a power metal-oxide-semiconductor transistor having a first terminal coupled to the series of light emitting diodes, a second terminal coupled to the output terminal of the amplifier, and a third terminal coupled to the second input terminal of the amplifier; and
a resistor coupled between the second input terminal of the amplifier and a ground for generating the driving current according to the reference voltage.

8. The driving circuit of claim 7, wherein the switch circuit comprises:
an inverter coupled to the signal-extending circuit; and
a switch coupled to the inverter.

9. The driving circuit of claim 8, wherein the switch is an N-type metal-oxide-semiconductor transistor.

10. The driving circuit of claim 7, wherein the power metal-oxide-semiconductor transistor is an N-type metal-oxide-semiconductor transistor.

11. A signal-extending circuit applied to a driving circuit for driving light emitting diodes, the signal-extending circuit comprising:
a first time-extending circuit for generating a first extending time for extending a duty cycle of an original dimming signal, the first time-extending circuit comprising:
a first metal-oxide-semiconductor transistor for receiving the original dimming signal;
a first capacitor coupled to the first metal-oxide-semiconductor transistor for generating the first extending time; and
a second metal-oxide-semiconductor transistor coupled to the first metal-oxide-semiconductor transistor for outputting a first extended dimming signal.

12. The signal-extending circuit of claim 11, wherein the signal-extending circuit further comprises:
a second time-extending circuit coupled to the first time-extending circuit for generating a second extending time for extending a duty cycle of the first extended dimming signal, the second time-extending circuit comprising:
a third metal-oxide-semiconductor transistor for receiving the first extended dimming signal;
a second capacitor coupled to the third metal-oxide-semiconductor transistor for generating the second extending time; and
a fourth metal-oxide-semiconductor transistor coupled to the third metal-oxide-semiconductor transistor for outputting a second dimming signal.

13. The signal-extending circuit of claim 12, wherein the second dimming signal is transmitted to a current sink of the driving circuit and the current sink generates a driving current for driving a series of light emitting diodes according to the second dimming signal.

14. The driving circuit of claim 13, wherein the driving current has a delay during rising, and the second dimming signal extends an additional time of the original dimming signal, and wherein the additional time of the original dimming signal is substantially the same as the delay during rising of the driving current.

15. The signal-extending circuit of claim 11, wherein the first dimming signal is transmitted to a current sink of the driving circuit and the current sink generates a driving current for driving a series of light emitting diodes according to the second dimming signal.

16. The driving circuit of claim 15, wherein the driving current has a delay during rising, and the first dimming signal extends an additional time of the original dimming signal, and wherein the additional time of the original dimming signal is substantially the same as the delay during rising of the driving current.

17. The signal-extending circuit of claim 11, wherein the original dimming signal is a pulse width modulation signal.
